(19) United States
(12) Patent Application Publication
(10) Pub. No.: US 2007/0134434 A1
(43) Pub. Date: Jun. 14, 2007

(54) Method for forming solder pattern on board

(76) Inventors: Hiroki Yokoyama, Yamaguchi (JP); Yuichiro Minabe, Yamaguchi (JP)

Correspondence Address: LADAS & PARRY LLP, 224 SOUTH MICHIGAN AVENUE, SUITE 1600, CHICAGO, IL, 60604, US

(21) Appl. No.: 11/605,034

(22) Filed: Nov. 28, 2006

(30) Foreign Application Priority Data
Nov. 29, 2005 (JP) 2005-343726

(51) Int. Cl. C08J 7/04

(52) U.S. Cl. 427/512

(57) ABSTRACT

The present invention provides a method which enables to save the trouble to prepare alloys having required particular compositions responding to the purposes and to prepare solder ink made from the alloys, and which enables to produce various forms of solder pattern on the board by adjusting the composition freely at the point of printing. The method for forming a solder pattern on a board by ink jet printing comprises the step of injecting two or more kinds of respective metal pastes on a board independently, wherein a solder composition of a solder pattern to be formed is adjusted by the amount of injection of the respective metal pastes in the area that the metal pastes are injected thereto.

### TECHNICAL FIELD

The present invention relates to a method for forming a solder pattern on a board. More specifically, the invention relates to a method for forming a solder pattern by ink jet printing on a wiring board for mounting electronic parts.

### BACKGROUND ART

When electronic parts are mounted on a wiring board, soldering by reflow process (hereinafter, refer to “reflow soldering”) is generally performed as a method for connecting electrode of electronic parts and wiring pattern of a board. In the process of reflow soldering, firstly, a solder is provided on a pad or a land in wiring pattern on the wiring board. Then, electronic parts are suitably disposed on the pad or the land and thermally treated to connect the electrode of electronic parts with wiring pattern. Conventionally, in the process of reflow soldering, as a method for providing solder on a pad or a land, a method to provide cream solder by screen printing method with use of metal mask is adopted.

In recent years, in association with miniaturization of electronic devices, miniaturization and high integration for wiring boards loaded thereon are required. Due to the requirement, size of the pad or the land on the wiring board becomes smaller. Thus, further precision for providing solder on the pad or the land is required. In addition, in association with a diversification of electronic devices, wide variety of wiring boards are required to be loaded on such devices. Because of this, production method shifts from a method for producing a massive amount of wiring board of the same kinds to a method for limited production of diversified products.

However, when precision printing of soldering is attempted by the above screen printing method, opening portions of the metal mask become microscopic in response to the precise printing pattern. In the opening portions, cream soldering to be used remains; thereby there are problems such that the cream soldering cannot easily come off from the metal mask, and printing on the board cannot be made. In this way, use of the above screen printing is not suitable for the precision printing. Also, the screen printing needs works such as changing the metal mask every time the printing pattern is changed. This is how the screen printing method is not suitable for limited production of diversified products.

As a method which enables to respond to the above limited production of diversified products and precision printing, a precision printing of soldering is attempted by adopting ink jet method. In the Patent Document 1, a soldering material for connecting, which is suitable for ink jet printing, is described. Patent Document 1: Japanese Patent Application Laid-Open (JP-A) No. 2005-161341

When the soldering material for connecting according to the Patent Document 1 is used, desired alloyed metal is made into microparticles by centrifugal spraying method and dispersed in the solvent with additive agent to obtain a soldering ink. The alloyed metal is a material constituted by a metal element to which one or more kinds of metal elements are consciously added. Depends on the number of main ingredient of metal element, the alloys are called, for example, secondary alloy, tertiary alloy, and quaternary alloy. Such alloys have infinite variation, depend on the kinds of main element and mixing ratio of the composing elements. In fact, various purposes require enormous variation of alloys.

Nevertheless, in conventional methods, such as a method for forming a solder pattern by ink jet printing with use of soldering materials for connecting described in Patent Document 1, primarily, alloys required for the purposes are produced, and the obtained alloys are made into microparticles by centrifugal spraying method to obtain the solder ink. Thus, the conventional methods take a lot of trouble to produce solder ink responding to the respective required alloys. In other words, for responding to the enormous number of alloys required for various purposes, processes in production of alloys and microparticulation thereof to obtain the desired solder ink need to be conducted repeatedly.

Accordingly, an object of the present invention is to provide a method, which enables to save the trouble to prepare alloys having required particular compositions responding to the purposes and to prepare solder ink made from the alloys, and which enables to produce various forms of solder pattern on the board by adjusting the composition freely at the point of printing.

### DISCLOSURE OF THE INVENTION

### Means for Solving the Problems

Hereinafter, the invention will be described. In the description, reference numerals of the attached drawing are referred in order to make the understanding of the present invention easier. However, the invention is not limited to the embodiment shown in the drawings.

A first aspect of the invention is a method for forming a solder pattern on aboard (60) by ink jet printing, which comprises the step of injecting two or more kinds of respective metal pastes (21-26) on a board independently, wherein a solder composition of a solder pattern to be formed is adjusted by the amount of injection of the respective metal pastes in the area (65) that the metal pastes are injected thereto.

A second aspect of the invention is a method for forming a solder pattern on a board (60) by ink jet printing machine having storage tanks (11-16), an injection nozzle (40), and lines (31-36) connecting between the nozzle and the storage tanks, which comprises the steps of: mixing two or more metal pastes (21-26), independently stored in storage tanks, in the line on the way to the injection nozzle at a predetermined ratio; and injecting the mixed two or more metal pastes from the injection nozzle onto the board.

In the first and the second aspects of the invention, the metal pastes are preferable to be selected from the group consisting of: gold paste (21), tin paste (22), silver paste (23), bismuth paste (24), indium paste (25), copper paste (26), and mixture thereof. If combinations of these metal pastes are used to conduct ink jet printing, solder patterns having various composition which is capable of responding to large number of purposes can be formed on a board. In addition, mixture of the metal pastes can be disposed. In this case, number of storage tanks, lines, and injection nozzles can be reduced.

In the above first and second aspects of the invention, as metal pastes, further, solder pastes for general-purpose (27) can be used. In this way, if a solder paste for general-purpose, which is frequently used, is disposed so as to make it ready for injection, this solder paste may be just injected when it receives a requirement to make a solder pattern having the same composition, which makes it possible to respond by simple methods for forming solder pattern.

In the above first and second aspects of the invention, metal pastes are preferable to be metal nanopastes including metal nanoparticles. Using metal nanoparticles having small particle diameters enable to adjust the viscosity of metal pastes to be suitable for ink jet printing, and enable to prevent from clogging of nozzle of ink jet printing machine.

A third aspect of the invention is a method for producing an electronic-parts mounted board, which comprises the steps of: forming solder pattern on a board (60) by a method according to the above first and second aspects of the invention; disposing electronic parts to certain positions on the board; and heating the solder pattern up to the melting point of solder or more. The third aspect of the invention has the same advantages as that of the above first and second aspects of the invention. But also, it has an advantage to respond to limited production of diversified products. Moreover, the third aspect of the invention can realize production of electronic-parts mounted boards on which microscopic solder patterns are formed and highly integrated.

### Effects of the Invention

According to the method of the invention for forming a solder pattern on a board, with use of ink jet printing, injecting two or more kinds of respective metal pastes (21-26) on a board (60) independently, or injecting a mixed metal paste thereof mixed in advance in line (30) on a board (60), enables to produce solder patterns having various compositions on a board. Thereby, it is possible to save the trouble to prepare solder ink responding to purposes in advance. Further, adoption of ink jet printing makes it possible to form microscopic patterns and to respond to limited production of diversified products.

### BRIEF DESCRIPTION OF THE DRAWINGS

FIG. 1 is a schematic view showing a general mechanism of ink jet printing machine;

FIGS. 2A and 2B are schematic views showing an ink jet printing machine using metal pastes composed of single constituent of metals in the method of a first embodiment of the present invention;

FIGS. 3A and 3B are schematic views of an ink jet printing machine having combinations of solder pastes in the method of the first embodiment of the invention; and

FIG. 4 is a schematic view of an ink jet printing machine, using a second embodiment of the invention.

### DESCRIPTION OF THE REFERENCE NUMERALS

10 storage tank
11-16 storage tanks corresponding to each metal paste
20 metal paste
21-26 each metal paste
gold (80% by mass)-tin (30% by mass) solder paste
30 line
31-36 lines corresponding to each metal paste
40 injection nozzle
41-46 injection nozzles corresponding to each metal
paste
60 board
65 position for forming a solder pattern

### MODE FOR CARRYING OUT THE INVENTION

[Ink Jet Printing]

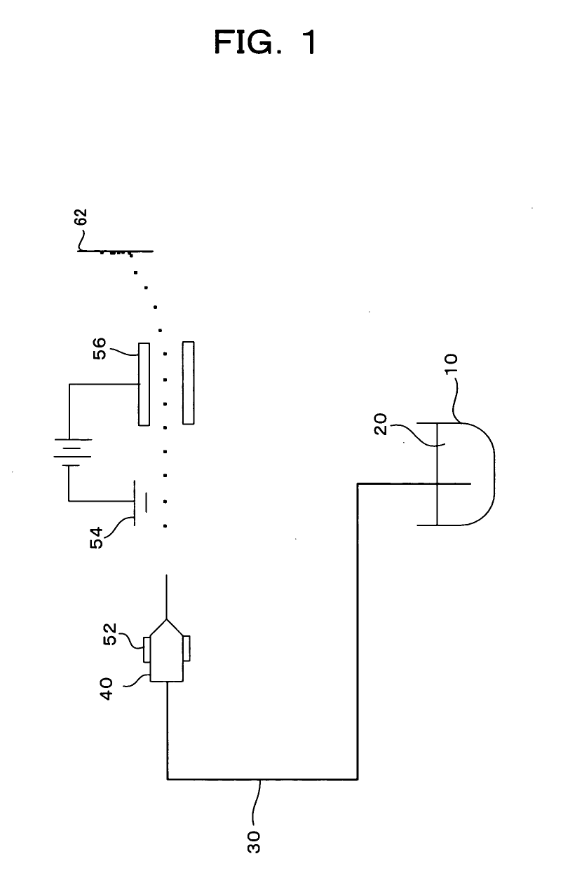

A first and a second embodiments of the present invention, both, form solder pattern on a board by ink jet printing. FIG. 1 is a schematic view showing a general mechanism of ink jet printing machine. In the embodiment shown in the drawing, an ink jet printing machine is constituted by a storage tank 10, a line 30, an injection nozzle 40, and ink control parts 52, 54, 56. The mechanism of the ink jet printing machine are as follows. Ink 20 in the storage tank 10 is transported into injection nozzle 40 through the line 30 by feed pump (not shown in the drawing.). Then, the ink 20 is injected from the injection nozzle 40 in a form of liquid column. The ink in a form of liquid column is made into predetermined size of ink particles by oscillation of electrostrictive element, and is charged at a charged electrode 54 up to a voltage corresponding to a printing position. Thereafter, the charged ink particles receive deflection corresponding to the amount of charge while passing between deflection electrodes 56, and finally, reach printing object 62 to be printed thereon.

Ink jet printing, compared with screen printing adopted in the conventional method for forming solder pattern, can provide precision printing. Also, as ink jet printing does not need to make and change screens such as metal mask for each solder pattern, ink jet printing is a suitable printing method for limited production of diversified products. The method of the invention is not particularly limited to apply to a certain device, if a device has ink jet type printing mechanism; the method can be applied to various devices. The printing method of the ink jet printing may be thermal ink jet printing or piezo-type; it is not particularly limited. Moreover, the board to form solder pattern thereon by the method of the invention is not limited to a certain board, if the board accepts wiring patterns to be formed thereon, and electronic parts to be loaded on top of that, the board can be adopted in the method of the invention. The structure of board may be any kind of structures such as single-sided board, double-sided board, or multilayer board. The material of board is not also particularly limited.

### THE FIRST EMBODIMENT OF THE INVENTION

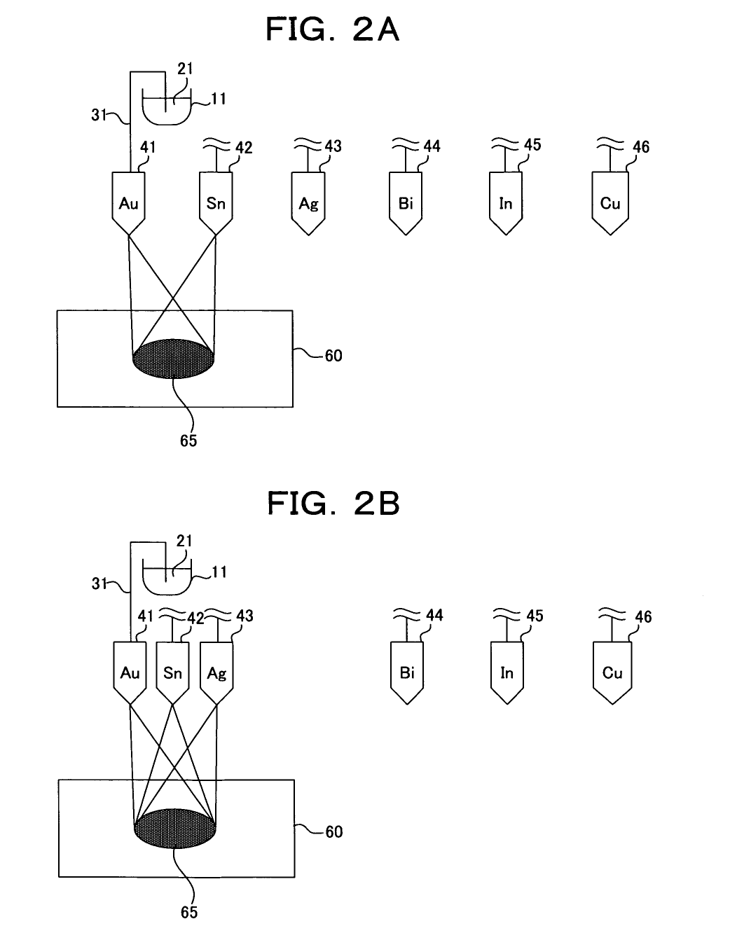

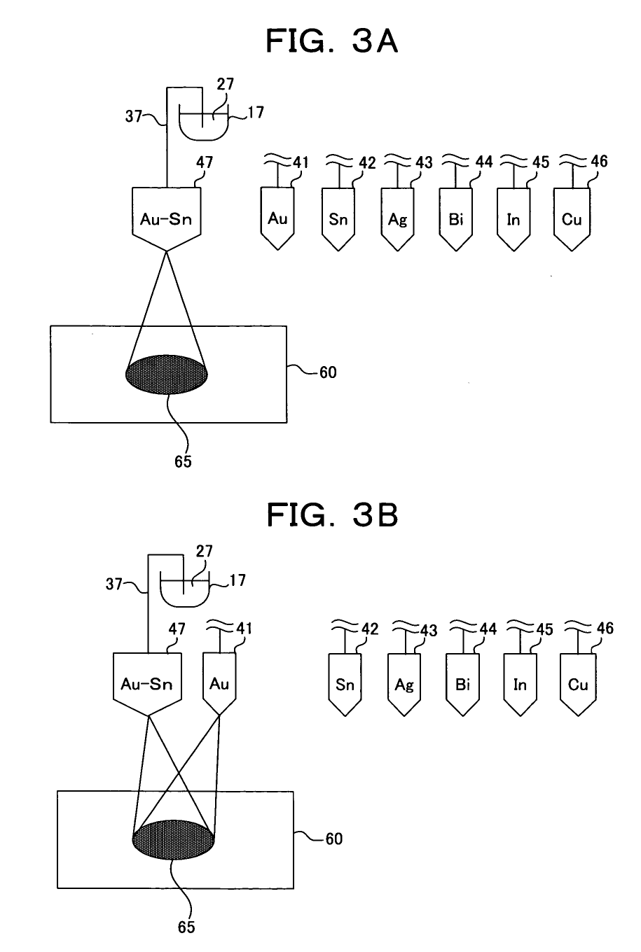

A general appearance of metal paste injection in the method of the first embodiment of the invention is schematically shown in FIGS. 2A, 2B and FIGS. 3A, 3B. FIGS. 2A and 2B are embodiments using metal pastes 21-26 each composed of single constituent of metal, FIGS. 3A and 3B are another embodiments using metal pastes 21-26 composed of single constituent of metals in combination with solder paste for general-purpose 27. In FIGS. 2A, 2B, and 3A, 3B a part of lines, of metal pastes, and of storage tanks are shown, and others are omitted.

In the first embodiment of the invention, by the type of above ink jet printing, two or more kinds of metal pastes 21-26 are independently injected onto the board 60, thereby a solder pattern are formed. The ink jet printing machine to be used in the first embodiment of the invention comprises storage tanks 11-16 corresponding to respective two or more metal pastes 21-26, lines 31-36 transporting the metal pastes, and injection nozzles 41-46.

In response to the required compositions of the solder pattern, two or more metal pastes are selected from metal pastes 21-26 each composed of single constituent of metal, and predetermined amount of these metal pastes is injected onto the position for forming a solder pattern 65 on the board 60. In this way, by adjusting solder composition of solder pattern to be formed with the injection amount of selected metal pastes, the desired solder patterns can be formed on the board 60.

(Metal Pastes 21-26)

As metal pastes 21-26 used in the invention, metal pastes conventionally used for forming wiring pattern on a board by ink jet printing can be used without any limitation. As such metal pastes, for example, a metal pastes described in Japanese Patent Application Laid-Open No. 2002-299833 can be used.

Metal particles constituting the metal pastes may be suitably selected depend on the required composition of solder patterns, the types of metal particles are not particularly limited. As the metal ingredients constituting generally required solder, six major metals, i.e. gold, tin, silver, bismuth, indium, and copper can be mainly named. The method of the invention, as shown in FIGS. 2A and 2B, preferably comprises the steps of: using six kinds of metal pastes made from these six metals, in other words, gold paste 21, tin paste 22, silver pastes 23, bismuth paste 24, indium paste 25, and copper paste 26; injecting these respective metal pastes from six nozzles 41-46; and forming a solder pattern on the board 60. By having such constitution, the method of the invention can respond to make most of the generally required solders. The method does not necessary use the above six kinds of metal pastes all at once. Two or more kinds of metal pastes selected from the six may be used. Which metal pastes are selected and equipped can be determined depend on the required solder patterns. Further, as an example, mixing a part of metal pastes in the predetermined ratio and injecting the metal paste mixture can also be possible. In such a case, the method is advantageous to be able to omit a part of equipment such as injection nozzle 40, line 30, and storage tank 10.

In addition, in this invention, not only the above metal pastes composed of single constituent of metals, but also solder alloyed metal pastes generally used as a solder for general-purpose can be used. As the composition of the alloyed metal, for example, gold-tin alloyed metal, tin-silver alloyed metal, tin-copper alloyed metal, tin-bismuth alloyed metal, indium-tin alloyed metal can be named.

In the case of solder alloyed metal pastes are used, as shown in FIGS. 3A and 3B, with the metal pastes 21-26 composed of single constituent of metals, the embodiment can have a constitution having a solder alloyed metal paste 27 injecting independently. The constitution of the combination of the metal pastes composed of single constituent of metals and the solder alloyed metal paste is described in detail in the following examples. And the embodiment can also have a constitution having two or more kinds of solder alloyed metal pastes with different composition, and a solder with a composition intermediate between the two or more can be prepared on the board.

In the ink jet printing, ink is injected from the nozzle in a form of liquid column to make it into a predetermined size of ink particles; the ink particles reach the printing object so as to complete the printing. Because of such mechanism, metal pastes to be used need a certain viscosity not to cause clogging of nozzle, and the viscosity is preferably at 100 mPa·s or below.

As seen above, from the viewpoint of the necessity in metal pasts having predetermined viscosity and of not causing clogging at the nozzle of ink jet printing machine, metal paste is preferable to be metal nanopastes having metal nanoparticles. In particular, the diameter of metal particles both in metal pastes composed of single constituent of metals and in solder alloyed metal pastes are preferably from 1 nm to 100 nm. The solder particles constituting solder pastes can be produced by solder alloy with use of centrifugal spraying method and gas atomize method.

(Injection System for Metal Pastes, etc.)

As an injection system of metal pastes and the like 21-27 from the nozzles 41-47 of an ink jet printing machine, a system of injecting two or more kinds of metal pastes and the like 21-27 simultaneously is preferable. Thereby, two or more kinds of metal pastes 21-26 of single constituent of metals are mixed one another, or the metal pastes 21-26 of single constituent of metals and solder alloyed metal paste 27 are mixed one another that make forming of solder having predetermined composition easier. Further, the system can be adopted that two or more kinds of metal pastes and the like 21-27 can be injected in turn. In such a case, a solder pattern to be formed is a multilayer structure made of metal pastes.

The thickness of the solder pattern formed by the injection of the above metal pastes and the like 21-27 is preferably from 0.5 μm to 10 μm. If the thickness of the solder pattern is too thin, it is difficult to connect electronic parts. On the other hand, if the thickness of the solder pattern is too thick, in the connecting process with electronic parts, solder runs out from area of pad or land, and that makes the precision wiring difficult.

### THE SECOND EMBODIMENT OF THE INVENTION

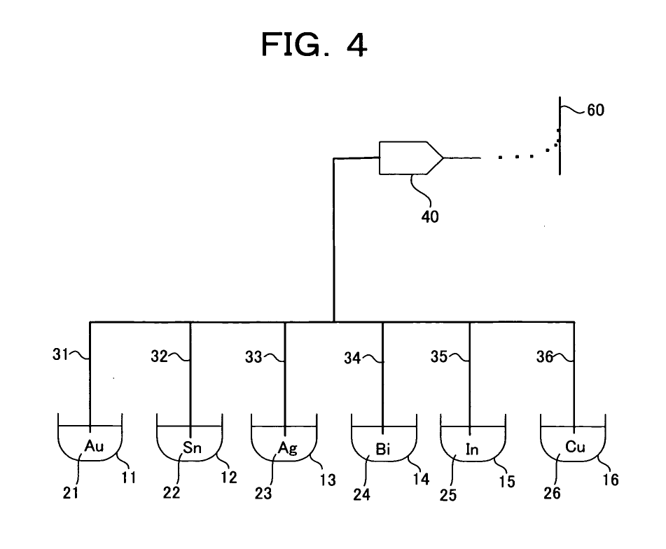

A general appearance of injection of metal pastes 21-26 in the method of the second embodiment of the invention is schematically shown in FIG. 4. The second embodiment of the invention uses an ink jet printing machine having storage tanks 11-16, an injection nozzle 40, and lines 31-36 connecting between the nozzle and the storage tanks to mix within the lines the metal pastes 21-26 in the storage tanks and to inject the mixed metal paste mixture from the injection nozzle 40 onto a board 60.

In the second embodiment of the invention, depending on the required composition of solder paste, by controlling the kinds and the amount of metal pastes to be supplied, predetermined composition of metal paste mixture is formed in the line. This metal paste mixture is injected onto the board 60 to obtain desired solder patterns. In the second embodiment of the invention, as the metal pastes 21-26 are mixed in advance and then injected onto the board 60, the embodiment has an advantage that solder patterns of which metal particles are homogenously mixed are easily produced. It has another advantage that solder patterns are easily melted in the connecting process (described later) with electronic parts.

[Connecting with Electronic Parts]

According to the invention, after forming a solder pattern on the board 60, electronic parts are loaded thereon. The process is as follows. Electronic parts are disposed at certain positions on pads or lands; when electrodes or the like of electronic parts contacting on the corresponding solder pattern, the board 60 is heated up to the melting point of solder or more. Thereby the solder is melted, and then, the solder is hardened by cooling the board. This is how electrodes and the like of electronic parts can be connected with the wiring pattern on the board 60 through the solder.

Hereinafter, melting mechanism of the formed solder pattern is described. In the first embodiment of the invention, when two or more kinds of metal pastes are injected simultaneously, and in the second embodiment of the invention, when metal paste mixture is injected, solder patterns formed by the invention is in a mixed condition with microparticles of the two or more kinds of metal pastes. In this condition, alloyed metal is formed at areas where microparticles of metal paste contact with each other. Thus, when the board 60 is heated up tomelting point of the alloy or more, firstly, the alloy existing between the microparticles is melt. Once, an alloyed part is melted, alloying spreads to the other parts. When all the metal pastes are alloyed, all the solder pattern are melted. In this way, the above electronic parts are connectted and a board which the electronic parts are loaded (hereinafter, it may be referred to “board which the electronic parts are loaded” as “electronic-parts mounted board”) is produced.

Furthermore, in the first embodiment of the invention, when multilayered structure of metal paste is formed by injecting two or more kinds of metal pastes in turn, alloy is formed in the interlayer part where metal paste layers contacting one another. Therefore, if the board 60 is heated, same as the above mechanism, this alloyed part is firstly melted, and alloying spreads to other parts to melt all (the solder pattern). Thereby, even in such a case that two or more kinds of metal paste are injected in turn, electronic parts can be connectted.

The third embodiment of the invention is a method for producing an electronic-parts mounted board, comprises the steps of: forming solder pattern on the board 60 by methods according to the above first and second embodiments of the invention; disposing electronic parts to certain positions on the board 60; and heating said solder pattern up to the melting point of solder or more.

Hereinafter, examples of the invention regarding a method for forming a solder pattern onto a board is shown; but a scope of the invention is not limited by these examples.

### EXAMPLE 1

When an ink jet printing machine shown in FIGS. 2A and 2B is used, if a solder pattern having gold (70% by mass)-tin (30% by mass) is required to form on the board 60, as shown in FIG. 2A, 70 parts by mass gold paste 21 is injected from the nozzle 41 to the certain position for forming solder pattern 65 on the board 60. At the same time, 30 parts by mass tin paste 22 is injected from the nozzle 42 to the position for forming a solder pattern 65 on the board. In this way, a solder pattern having gold (70% by mass)-tin (30% by mass) can be formed at the position for forming a solder pattern 65 on the board 60.

Moreover, when an engineering change is made by a client from the above composition to the composition having gold (70% by mass)-tin (20% by mass)-silver (10% by mass), as shown in FIG. 2B, gold paste 21 of 70 parts by mass is injected from nozzle 41 to the position 65 on the board. At the same time, tin paste 22 of 20 parts by mass is injected from the nozzle 42 to the position 65 on the board. Further, at the same time, silver paste 23 of 10 parts by mass is injected from the nozzle 43 to the position 65 on the board. In these manners, a solder pattern of gold (70% by mass)-tin (20% by mass)-silver (10% by mass) can be formed at the position 65 on the board 60. In such a case where the requirement of client changes, the ink jet printing machine adopting the method of the invention can simply and quickly respond to the solder pattern having the new composition by newly injecting the silver paste 23 disposed in advance and adjusting the injection amount of each metal pastes 21, 22, and 23.

### EXAMPLE 2

In FIGS. 3A and 3B, as an example of the invention, an ink jet printing machine: having nozzles 41-46 corresponding to respective metal pastes, i.e. gold, tin, silver, bismuth, indium, and copper; and a nozzle 47 corresponding to a solder paste 27 consists of a solder with gold (70% by mass)-tin (30% by mass), is schematically shown.

When an ink jet printing machine shown in FIGS. 3A and 3B is used, if a solder pattern having gold (70% by mass)-tin (30% by mass) is required to form, as shown in FIG. 3A, a solder pattern having gold (70% by mass)—tin (30% by mass) can be formed at the position for forming a solder pattern 65 on the board 60, by injecting gold-tin solder paste 27 from the nozzle 47.

Furthermore, when an engineering change is made by the client from the above composition to the composition having gold (80% by mass)-tin (20% by mass) as shown in FIG. 3B, a solder pattern with gold (80% by mass)-tin (20% by mass) can be formed at the position 65, by adjusting injection amount such that the ratio of gold and tin becomes 80% by mass and 20% by mass and injecting the solder paste 27 with gold (70% by mass)—tin (20% by mass) and gold paste 21, respectively.

In this way, by disposing the frequently used solder alloyed metal paste 27 for general-purpose, if a solder pattern of the same composition as the solder paste 27 is required, this solder alloyed metal paste 27 for general-purpose may only be injected. So, the method of the present invention is very simple method, and from the viewpoint of operation and cost, it is very advantageous method. In addition, using this solder composition as a core, when composition change is made, respond to the change of solder pattern can be simply and quickly made by injecting other single constituent of metal pastes 21-26 simultaneously.

The above has described the present invention associated with the most practical and preferred embodiments thereof. However, the invention is not limited to the embodiments disclosed in the specification. Thus, the invention can be appropriately varied as long as the variation is not contrary to the subject substance and conception of the invention which can be read out from the claims and the whole contents of the specification. It should be understood that a method for forming a solder pattern on a board with such an alternation are included in the technical scope of the invention.

What is claimed is:

1. A method for forming a solder pattern on a board by ink jet printing, comprising the step of:
injecting two or more kinds of respective metal pastes on a board independently,
wherein a solder composition of a solder pattern to be formed is adjusted by the amount of injection of said respective metal pastes in the area that said metal pastes are injected thereto.

2. A method for forming a solder pattern on a board according to claim 1, wherein said metal pastes are selected from the group consisting of: gold paste, tin paste, silver paste, bismuth paste, indium paste, copper paste, and mixture thereof.

3. A method for forming a solder pattern on a board according to claim 1, wherein, said metal pastes are solder alloyed metal pastes.

4. A method for forming a solder pattern on a board according to claim 1, wherein, as said metal pastes, at least one metal paste selected from the group consisting of: gold paste, tin paste, silver paste, bismuth paste, indium paste, copper paste, and mixture thereof; and solder alloyed metal pastes are both used.

5. A method for forming a solder pattern on a board according to claim 1, wherein said metal pastes are a metal nanopastes including metal nanoparticles.

6. A method for producing an electronic-parts mounted board, comprising the steps of:
forming a solder pattern on a board by a method according to claim 1;
disposing electronic parts to certain positions on said board; and
heating said solder pattern up to the melting point of solder or more.

7. A method for forming a solder pattern on a board by ink jet printing machine having storage tanks, an injection nozzle, and lines connecting between said nozzle and said storage tanks, comprising the steps of:
mixing two or more kinds of metal pastes, independently stored in said storage tanks, in said lines on the way to said injection nozzle at a predetermined ratio; and
injecting said mixed two or more kinds of metal pastes from said injection nozzle onto a board.

8. A method for forming a solder pattern on a board according to claim 7, wherein said metal pastes are selected from the group consisting of: gold paste, tin paste, silver paste, bismuth paste, indium paste, copper paste, and mixture thereof.

9. A method for forming a solder pattern on a board according to claim 7, wherein, said metal pastes are solder alloyed metal pastes.

10. A method for forming a solder pattern on a board according to claim 7, wherein, as said metal pastes, at least one metal paste selected from the group consisting of: gold paste, tin paste, silver paste, bismuth paste, indium paste, copper paste, and mixture thereof; and solder alloyed metal pastes are both used.

11. A method for forming a solder pattern on a board according to claim 7, wherein said metal pastes are a metal nanopastes including metal nanoparticles.

12. A method for producing an electronic-parts mounted board, comprising the steps of:
forming a solder pattern on a board by a method according to claim 7;
disposing electronic parts to certain positions on said board; and
heating said solder pattern up to the melting point of solder or more.
